(19) United States
(12) Patent Application Publication
(10) Pub. No.: US 2022/0155083 A1
(43) Pub. Date: May 19, 2022

(54) SYSTEMS AND METHODS FOR RANGE ESTIMATIONS FOR ELECTRIFIED TRANSIT VEHICLES

(71) Applicant: Cummins Inc., Columbus, IN (US)

(72) Inventors: Omkar A. Harshe, Columbus, IN (US); Mugdha S. Sane, Columbus, IN (US); Shiva K. Sooryavaram, Columbus, IN (US); Tzu Him Young, Columbus, IN (US)

(21) Appl. No.: 17/526,197

(22) Filed: Nov. 15, 2021

Related U.S. Application Data
(60) Provisional application No. 63/114,215, filed on Nov. 16, 2020.

(51) Int. Cl. G01C 21/34; G06N 20/00; B60L 58/16; G01S 19/42

(52) U.S. Cl. CPC G01C 21/3453; G01S 19/42; B60L 58/16; G06N 20/00

(57) ABSTRACT

At least some embodiments of the present disclosure are directed to systems and methods for route identifications and/or range estimations. The system is configured to generate a plurality of routes and a plurality of sub-routes based on transit route information and/or historical telematics data. The system is configured to receive or obtain location information of an electrified transit vehicle and identify a route/sub-route being taken by the electrified transit vehicle based on the location information. In some cases, the system is configured to determine a range estimation of the electrified transit vehicle based on the location information and the identified route/sub-route.

### RELATED APPLICATIONS

This application is claims benefit to U.S. Provisional Application No. 63/114,215, filed Nov. 16, 2020, the disclosure of which is hereby expressly incorporated herein by reference.

### TECHNICAL FIELD

The present disclosure generally relates to providing route identifications and/or range estimations for electrified transit vehicles.

### BACKGROUND

Recently, there has been an increased demand for vehicles with electrified powertrains to improve fuel economy and reduce emissions, e.g., vehicles with multiple forms of motive power. Some electrified powertrains include an engine (e.g., internal combustion engine), motor/generator(s) and battery(s). The engine can produce drive torque that is transferred to the hybrid drivetrain and charge the battery(s). When the battery(s) is(are) sufficiently charged, the electrified powertrain can operate without using the engine. Some electrified powertrains are powered only by electricity, such as battery(s). Reliable range estimations are needed for vehicles using electrified powertrains.

### SUMMARY

Transit vehicles usually travel in preset routes. In some embodiments, a transit route includes a preset start location, a preset end location, and one or more preset transit stop locations. In some cases, the transit vehicles, including electrified transit vehicles, may travel in different sub-routes for a preset route, for example, due to traffic, due to road constructions, and/or the like. As an example, a transit vehicle is a bus. As used herein, a sub-route refers to a path taken by a transit vehicle. In one example, a route taken in a opposite direction is referred to as a different sub-route. Route information can be retrieved from General Transit Feed Specification (GTFS) database or from other transit data source. Identifying the sub-route being taken by an electrified transit vehicle can improve the range estimation (i.e., estimation of driving range) of the electrified transit vehicle. In some embodiments, altitude information is obtained for location(s) in sub-route(s) and can be used in the range estimation.

As recited in examples, Example 1 is a method implemented by a system having one or more processors and one or more memories. The method comprises the steps of: receiving transit route information from a transit data source; generating a plurality of routes and a plurality of sub-routes based on the transit route information, each route of the plurality of routes comprising one or more sub-routes having a different path from each other; receiving location information of an electrified transit vehicle; identifying a sub-route being taken by the electrified transit vehicle based on the location information, the identified sub-route being one of the plurality of sub-routes; and determining a range estimation of the electrified transit vehicle based on the location information and the identified sub-route.

Example 2 is the method of Example 1, further comprising: generating a plurality of scores associated with a plurality of selected sub-routes for the electrified transit vehicle, each score of the plurality of scores being associated with a respective sub-route and generated based on a distance between a location of the electrified transit vehicle and the respective sub-route; wherein the identified sub-route is determined based on the plurality of scores.

Example 3 is the method of Example 2, wherein the distance is determined using GPS coordinates associated with the location and GPS coordinates associated with the respective sub-route.

Example 4 is the method of any one of Examples 1-3, wherein the location information comprises a time sequence of GPS coordinates, the method further comprising: determining a trip of the electrified transit vehicle by determining a start location of the trip, wherein the start location is determined based on stationary time of the electrified transit vehicle greater than a threshold.

Example 5 is the method of Example 4, wherein the threshold is a predetermined threshold.

Example 6 is the method of Example 4, wherein the threshold is adjusted based on the location information.

Example 7 is the method of any one of Examples 1-6, further comprising: receiving historical telematics data associated with the transit route information, historical telematics data associated with a specific transit route comprising a time sequence of GPS coordinates associated with the specific transit route, the historical telematics data associated with the specific route further comprises data indicative of an altitude associated with a location in the specific transit route; wherein generating a plurality of routes and a plurality of sub-routes comprises generating the plurality of routes and the plurality of sub-routes based on the transit route information and the historical telematics data.

Example 8 is the method of Example 7, wherein generating a plurality of routes and a plurality of sub-routes comprises generating the plurality of routes and the plurality of sub-routes using a machine learning model, wherein the machine learning model is trained using at least a part of the historical telematics data.

Example 9 is the method of Example 7, wherein each sub-route of the plurality of sub-routes comprises a sequence of GPS coordinates and at least one altitude associated with one GPS coordinates in the sequence of GPS coordinates, wherein determining a range estimation of the electrified transit vehicle comprises determining the range estimation based on a sequence of GPS coordinates and at least one altitude of the identified sub-route.

Example 10 is the method of any one of Examples 1-9, wherein determining a range estimation of the electrified transit vehicle comprises determining the range estimated based on the location information, the identified sub-route and operating conditions of the electrified transit vehicle.

Example 11 is a system comprising: one or more processors having instructions; and one or more memories configured to execute the instructions to perform operations comprising: receiving transit route information from a transit data source; generating a plurality of routes and a plurality of sub-routes based on the transit route information, each route of the plurality of routes comprising one or more sub-routes having a different path from each other; receiving location information of an electrified transit vehicle; identifying a sub-route being taken by the electrified transit vehicle based on the location information, the identified sub-route being one of the plurality of sub-routes; and determining a range estimation of the electrified transit vehicle based on the location information and the identified sub-route.

Example 12 is the system of Example 11, wherein the operations further comprise: generating a plurality of scores associated with a plurality of selected sub-routes for the electrified transit vehicle, each score of the plurality of scores being associated with a respective sub-route and generated based on a distance between a location of the electrified transit vehicle and the respective sub-route; wherein the identified sub-route is determined based on the plurality of scores.

Example 13 is the system of Example 12, wherein the distance is determined using GPS coordinates associated with the location and GPS coordinates associated with the respective sub-route.

Example 14 is the system of any one of Examples 11-13, wherein the location information comprises a time sequence of GPS coordinates, wherein the operations further comprise: determining a trip of the electrified transit vehicle by determining a start location of the trip, wherein the start location is determined based on stationary time of the electrified transit vehicle greater than a threshold.

Example 15 is the system of Example 14, wherein the threshold is a predetermined threshold.

Example 16 is the system of Example 14, wherein the threshold is adjusted based on the location information.

Example 17 is the system of any one of Examples 11-16, wherein the operations further comprise: receiving historical telematics data associated with the transit route information, historical telematics data associated with a specific transit route comprising a time sequence of GPS coordinates associated with the specific transit route, the historical telematics data associated with the specific route further comprises data indicative of an altitude associated with a location in the specific transit route; wherein generating a plurality of routes and a plurality of sub-routes comprises generating the plurality of routes and the plurality of sub-routes based on the transit route information and the historical telematics data.

Example 18 is the system of Example 17, wherein generating a plurality of routes and a plurality of sub-routes comprises generating the plurality of routes and the plurality of sub-routes using a machine learning model, wherein the machine learning model is trained using at least a part of the historical telematics data.

Example 19 is the system of Example 17, wherein each sub-route of the plurality of sub-routes comprises a sequence of GPS coordinates and at least one altitude associated with one GPS coordinates in the sequence of GPS coordinates, wherein determining a range estimation of the electrified transit vehicle comprises determining the range estimation based on a sequence of GPS coordinates and at least one altitude of the identified sub-route.

Example 20 is the system of any one of Examples 11-19, wherein determining a range estimation of the electrified transit vehicle comprises determining the range estimated based on the location information, the identified sub-route and operating conditions of the electrified transit vehicle.

Example 21 is a method implemented by a system having one or more processors and one or more memories. The method comprises the steps of: receiving historical telematics data associated with transit routes, historical telematics data associated with a specific transit route comprising a time sequence of GPS coordinates associated with the specific transit route, the historical telematics data associated with the specific route further comprises data indicative of an altitude associated with a location in the specific route; generating a plurality of routes and a plurality of sub-routes based on the historical telematics data, each route of the plurality of routes comprising one or more sub-routes having a different path from each other, each sub-route comprising at least one altitude associated with one GPS coordinates in the sequence of GPS coordinates; receiving a location information of an electrified transit vehicle; identifying a sub-route being taken by the electrified transit vehicle based on the location information, the identified sub-route being one of the plurality of sub-routes; and determining a range estimation of the electrified transit vehicle based on the location information and the identified sub-route.

Example 22 is the method of Example 21, wherein generating a plurality of routes and a plurality of sub-routes comprises generating the plurality of routes and the plurality of sub-routes using a machine learning model, wherein the machine learning model is trained using at least a part of the historical telematics data.

Example 23 is a system comprising: one or more processors having instructions; and one or more memories configured to execute the instructions to perform operations comprising: receiving historical telematics data associated with transit routes, historical telematics data associated with a specific transit route comprising a time sequence of GPS coordinates associated with the specific transit route, the historical telematics data associated with the specific route further comprises data indicative of an altitude associated with a location in the specific route; generating a plurality of routes and a plurality of sub-routes based on the historical telematics data, each route of the plurality of routes comprising one or more sub-routes having a different path from each other, each sub-route comprising at least one altitude associated with one GPS coordinates in the sequence of GPS coordinates; receiving a location information of an electrified transit vehicle; identifying a sub-route being taken by the electrified transit vehicle based on the location information, the identified sub-route being one of the plurality of sub-routes; and determining a range estimation of the electrified transit vehicle based on the location information and the identified sub-route.

Example 24 is the system of Example 23, wherein generating a plurality of routes and a plurality of sub-routes comprises generating the plurality of routes and the plurality of sub-routes using a machine learning model, wherein the machine learning model is trained using at least a part of the historical telematics data.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 depicts an illustrative diagram for an electrified transit vehicle system, in accordance with embodiments of the subject matter of the disclosure;

FIG. 2 is an example flow diagram depicting an illustrative method of route identifications/range estimations for electrified transit vehicles, in accordance with embodiments of the subject matter of the disclosure;

FIG. 3 is another example flow diagram depicting an illustrative method of route identifications/range estimations for electrified transit vehicles, in accordance with embodiments of the subject matter of the disclosure;

FIG. 4 is an example flow diagram depicting an illustrative method of pre-processing historical telematics data to be used to train a machine learning model, in accordance with embodiments of the present disclosure; and

FIG. 5 depicts an example electrified transit vehicle environment, in accordance with embodiments of the subject matter of the disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, when an element, component, device or layer is described as being “on” “connected to,” “coupled to” or “in contact with” another element, component, device or layer, it can be directly on, directly connected to, directly coupled with, in direct contact with, or intervening elements, components, devices or layers may be on, connected, coupled or in contact with the specific element, component or layer, for example. When an element, component, device or layer for example is referred to as being “directly on,” “directly connected to,” “directly coupled to,” or “directly in contact with” another element, component, device or layer, there are no intervening elements, components, devices or layers for example.

Although illustrative methods may be represented by one or more drawings (e.g., flow diagrams, communication flows, etc.), the drawings should not be interpreted as implying any requirement of, or specific order among or between, various steps disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” “series” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a specific piece of information may additionally, or alternatively, base the same determination on another piece of information.

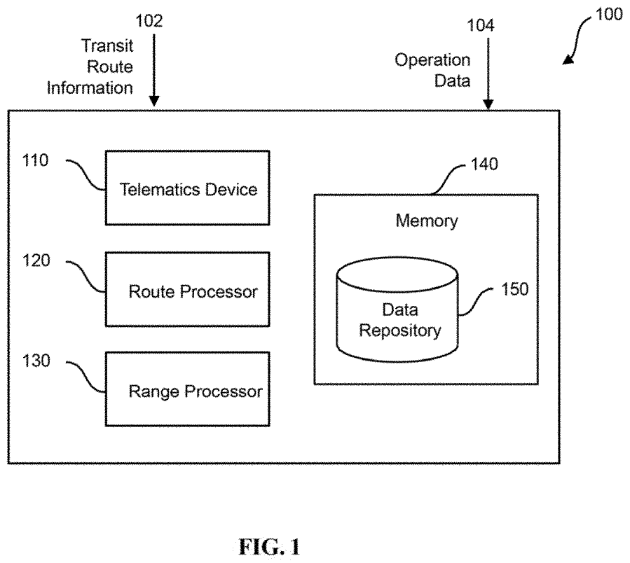

FIG. 1 depicts an illustrative diagram of an electrified transit vehicle system 100, in accordance with embodiments of the subject matter of the disclosure. In some implementations, one or more components of the system 100 can be optional. In some implementations, the system 100 can include other components not illustrated in the diagram. In the illustrated example, the electrified transit vehicle system 100 includes telematics device(s) 110, a route processor 120, a range processor 130, one or more memories 140, and one or more data repositories 150. The system 100 may receive transit route information 102 from a transit data source. In one example, the transit data source includes a GTFS database, where the system retrieves the transit route information from the GTFS database. In another example, the transit data source includes a transit system, and the electrified transit vehicle system 100 and/or the route processor 120 is configured to receive the transit route information via s software interface (e.g., API, web service, etc.).

The electrified transit vehicle system 100 may receive operation data 104 of one or more electrified transit vehicles. The operation data includes, for example, speed, power level of the engine, torque, battery health (e.g., the efficiency of retaining charges), battery state-of-charge (SOC), brake thermal efficiency (BTE), and/or the like. The operation data may also include vehicle sensor data such as, for example, noise data, vibration data, harshness data, exhaust gas temperature, catalyst temperature, altitude data, and/or the like. In some embodiments, the electrified transit vehicle includes an altitude sensor, for example, a barometric sensor.

In some implementations, the route processor 120 is configured to receive historical telematics data for transit routes. In some cases, the route processor 120 is configured to retrieve the historical telematics data from the data repository 150. The historical telematics data can be generated from respective telematics devices of electrified transit vehicles. In some cases, historical telematics data associated with a specific transit route includes a time sequence of GPS coordinates associated with the specific transit route. In some cases, the historical telematics data associated with the specific route further includes data indicative of an altitude associated with a location in the specific transit route. In some cases, the historical telematics data associated with the specific route further includes data indicative of a plurality of altitudes associated with a plurality of locations in the specific transit route. In some cases, altitude data is collected from barometric sensors on transit vehicles. In some cases, altitude data is retrieved from a data source. In one example, altitude data is retrieved from a data source using location information as inputs.

In some embodiments, the route processor 120 is configured to generate a plurality of routes and a plurality of sub-routes, where each route of the plurality of routes includes one or more sub-routes having a different path from each other. As used herein, a route refers to a transit route having a specific start location and a specific end location. In some cases, the specific start location and the specific end location are the same location. In some cases, a sub-route includes a sequence of GPS coordinates. In some implementations, a plurality of sub-routes of a route have a different path/direction from each other, while the plurality of sub-routes have the same starting location and the same end location. In certain implementations, a plurality of sub-routes of a route have a different path/direction from each other, while the plurality of sub-routes have the same starting location, the same end location, and one or more same transit stop locations. In some cases, a sub-route includes a time sequence of GPS coordinates. In some cases, a route with a first direction is a different sub-route from the route with a second direction opposing the first direction. In some implementations, each sub-route has an associated shape when being plotted. In some embodiments, a sub-route includes more information about the route, such as altitude information.

In some cases, the route processor 120 is configured to process the transit route information to generate the plurality of routes and the plurality of sub-routes. In some embodiments, the route processor 120 is configured to identify a route-change to generate the plurality of routes and the plurality of sub-routes. In some cases, the route-change is determined if the stationary time is greater than a threshold. In one example, the threshold is a predetermined threshold. In some cases, a sub-route includes a sequence of GPS coordinates and at least one altitude associated with one GPS coordinates in the sequence of GPS coordinates. In some cases, a sub-route includes a sequence of GPS coordinates and associated altitudes.

In some cases, the route processor 120 is configured to process the historical telematics data to generate the plurality of routes and the plurality of sub-routes. In some cases, the route processor 120 is configured to process the transit route information and the historical telematics data to generate the plurality of routes and the plurality of sub-routes. In some cases, the route processor 120 is configured to update the plurality of sub-routes with altitude information, for example, using the historical telematics data. In some cases, the altitude information includes the altitude for each GPS coordinates in the sub-route. In some cases, the altitude information includes altitude data for selected GPS coordinates in the sub-route. In some cases, the altitude information is collected from GPS grid information. In some cases, the route processor 120 is configured to generate the plurality of routes and the plurality of sub-routes using the trained machine learning model, wherein the machine learning model is trained using at least a part of the historical telematics data.

In some embodiments, the route processor 120 and/or the range processor 130 is configured to train a machine learning model using the historical telematics data and/or historical operation data. In some embodiments, the route processor 120 and/or the range processor 130 is configured to train a machine learning model using a first subset of the historical telematics data and/or historical operation data. In some cases, the first subset of the historical telematics data is selected using a pre-processing process. The machine learning model may include any suitable machine learning models, deep learning models, and/or the like. In some embodiments, the machine learning model includes at least one of a decision tree, random forest, support vector machine, convolutional neural network, recurrent neural network, and/or the like. Optionally, the route processor 120 and/or the range processor 130 may test the trained machine learning model using a second subset of the historical telematics data and/or historical operation data. In one embodiment, the first subset of the historical telematics data and/or historical operation data and the second subset of the historical telematics data and/or historical operation data do not have any overlapping dataset. In another embodiment, the first subset of the historical telematics data and the second subset of the historical telematics data have at least one overlapping dataset.

In some cases, the machine learning model includes an image classification machine learning model. In some cases, the route processor 120 is configured to generate a plot using GPS coordinates for each sub-route and the machine learning model is trained to identify the shape of the plot. In some embodiments, the machine learning model comprises a neural network. In some cases, the neural network comprises a plurality of layers. In one embodiments, the neural network includes at least an input layer, one or more hidden layers, and an output layer. In some embodiments, at least one input layer of the neural network is for telematics data. In some embodiments, at least one input layer of the neural network is for operation data. In one example, the machine learning model is trained to identify locations using the telematics data.

In some cases, the machine learning model is trained using both the historical telematics data and historical operation data. The operation data includes, for example, battery state-of-charge, distance travelled, brake thermal efficiency, and other operation data for an electrified vehicle. In some embodiments, the machine learning model is trained to predict a range estimation using the historical telematics data and the historical operation data. In one example, the machine learning model is a neural network including an input layer for telematics data, an input layer for operation data, an input layer for route information, and/or an output layer for range estimation. In one embodiment, the machine learning model includes a plurality of machine learning models, where a first machine learning model is configured to take inputs of telematics data and route information to predict route, and a second machine learning model is configured to get the predicted route and the operation data as inputs to predict driving range. In one example, the first machine learning model includes an image classification machine learning model.

In some cases, the route processor 120 and/or the range processor 130 is configured to receive location information of an electrified transit vehicle. In some embodiments, the location information includes data collected from one or more telematics devices 110 of the electrified transit vehicle. In some cases, the location information includes data collected from a mobile device in the electrified transit vehicle. In one example, the location information includes a sequence of GPS coordinates. In one example, the location information includes a time sequence of GPS coordinates. In some embodiments, the location information includes speed information and/or brake information of the electrified transit vehicle.

In some implementations, the route processor 120 is configured to determine a trip of the electrified transit vehicle based on the location information. In some cases, the electrified transit vehicle takes a plurality of different routes/sub-routes. In such cases, the route processor 120 is configured to determine a start location of a trip based on stationary time of the vehicle. In some cases, the start location is determined if the stationary time is greater than a threshold. In one example, the threshold is a predetermined threshold. In another example, the route processor 120 is configured to adjust the threshold, for example, based on the collected telematics data, the location information, and/or the like.

In some embodiments, the route processor 120 is configured to determine a plurality of scores associated with the trip, for example, in comparison to the generated sub-routes. The scores are also referred to as sub-route scores. In some cases, the route processor 120 is configured to determine a plurality of scores associated with a plurality of selected sub-routes for the electrified transit vehicle, where each score of the plurality of scores is associated with a respective sub-route and generated based on a distance between a location of the electrified transit vehicle and the respective sub-route. In some cases, the distance is determined based on GPS coordinates. In some cases, a score for a sub-route can be determined based on a plurality of locations of the electrified transit vehicle and the respective sub-route. In one example, the score for a sub-route is determined based on the smallest distance of the plurality of the locations of the electrified transit vehicle to the respective sub-route.

In one example, the score for a sub-route is determined based on the average distance of the plurality of the locations of the electrified transit vehicle to reference locations of the respective sub-route. In one example, a distance of a location to a sub-route is computed using the shortest distance from the location to the sub-route. For example, the route processor 120 may use Delaunay Triangulation algorithm to compute the distance. In some cases, the score is a normalized score based on the distances computed to a plurality of sub-routes. In one example, the score is normalized using the number of reference locations identified in the sub-routes. In some cases, the score is determined using the trained machine learning model. In some cases, the score is determined using the trained artificial neural network, where the artificial neural network includes an output layer for sub-route scores.

In some implementations, the route processor 120 is configured to identify a sub-route taken by the electrified transit vehicle, for example, based on the location information and/or the plurality of scores. In one embodiment, the identified sub-route has the lowest sub-route score of the scores determined for the sub-routes. In some cases, the range processor 130 is configured to receive operating conditions of the electrified transit vehicle. In some cases, the operating conditions of the electrified transit vehicle can include, for example, battery state-of-charge, torque, brake thermal efficiency, and/or the like.

In some embodiments, the range processor 130 is configured to determine a range estimation of the electrified transit vehicle, for example, based on the location information and the identified sub-route. In some cases, the range processor 130 is configured to determine the range estimation based on the operating conditions/data, the location information, and the identified sub-route. In some cases, the range processor 130 is configured to determine the range estimation based at least in part on altitude information of the identified sub-route. In one example, the altitude information is used to predict future power consumptions of the electrified transit vehicle when traveling in the identified sub-route. In some cases, the range processor 130 is configured to predict the range estimation using the trained machine learning model. In one example, the range estimation is predicted using the trained artificial neural network, where the artificial neural network includes an output layer for range estimation.

In some embodiments, the range processor 130 may use an adaptive algorithm which learns from historical data (e.g., energy spent over distance traveled) to determine the distance vehicle can travel in the remaining energy available in the battery. With the information of the identified sub-route the vehicle is traveling, the accuracy of range estimation can be improved.

In some embodiments, a computing device (e.g., the route processor 120, the range processor 130, the electrified transit vehicle system 100) includes a communication bus that, directly and/or indirectly, couples the following devices: a processor, a memory, an input/output (I/O) port, an I/O component, and a power supply. Any number of additional components, different components, and/or combinations of components may also be included in the computing device. In some cases, the computing device can include one or more cloud servers. The communication bus represents what may be one or more busses (such as, for example, an address bus, data bus, or combination thereof). Similarly, in some embodiments, the computing device may include a number of processors, a number of memory components, a number of I/O ports, a number of I/O components, and/or a number of power supplies. Additionally, any number of the components (e.g., the route processor 120, the range processor 130) of the electrified transit vehicle system 100, or combinations thereof, may be distributed and/or duplicated across a number of computing devices.

In some embodiments, the memory 140 includes computer-readable media in the form of volatile and/or nonvolatile memory, transitory and/or non-transitory storage media and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In some embodiments, the memory 140 stores computer-executable instructions for causing a processor (e.g., the route processor 120, the range processor 130) to implement aspects of embodiments of system components discussed herein and/or to perform aspects of embodiments of methods and procedures discussed herein.

Computer-executable instructions may include, for example, computer code, machine-useable instructions, and the like such as, for example, program components capable of being executed by one or more processors associated with a computing device. Program components may be programmed using any number of different programming environments, including various languages, development kits, frameworks, and/or the like. Some or all of the functionality contemplated herein may also, or alternatively, be implemented in hardware and/or firmware.

The data repository 150 may store telematics data, transit route information, generated routes and sub-routes, operation data, range estimations, and/or other data. The data repository 150 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository 150 may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

Various components of the system 100 can communicate via or be coupled to via a communication interface, for example, a wired or wireless interface. The communication interface includes, but is not limited to, any wired or wireless short-range and long-range communication interfaces. The wired interface can use cables, wires, and/or the like. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

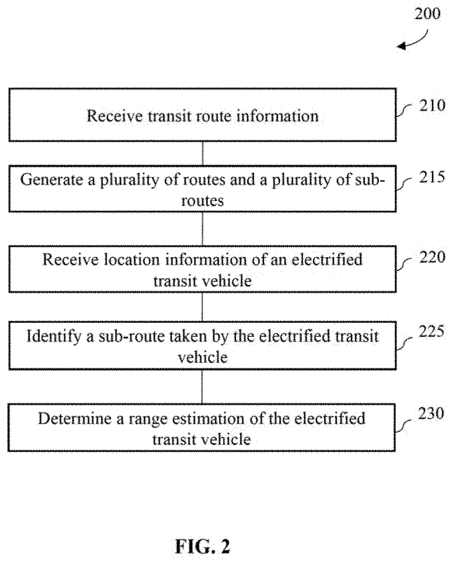

FIG. 2 is an example flow diagram depicting an illustrative method 200 of route identifications/range estimations for electrified transit vehicles, in accordance with embodiments of the present disclosure. Aspects of embodiments of the method 200 may be performed, for example, by one or more processor or system (e.g., the route processor 120 and/or the range processor 130 in FIG. 1, the electrified transit vehicle system 100 in FIG. 1). One or more steps of method 200 are optional and/or can be modified by one or more steps of other embodiments described herein. Additionally, one or more steps of other embodiments described herein may be added to the method 200. First, the electrified transit vehicle system receives transit route information (210) from a transit data source. In one example, the transit data source includes a GTFS database, where the route processor is con. In another example, the transit data source includes a transit system, and the route processor is configured to receive the transit route information via s software interface (e.g., API, web service, etc.).

In some embodiments, the electrified transit vehicle system is configured to generate a plurality of routes and a plurality of sub-routes (215), where each route of the plurality of routes includes one or more sub-routes having a different path from each other. In some cases, a sub-route includes a sequence of GPS coordinates. In some cases, a sub-route includes a time sequence of GPS coordinates. In some cases, a path/route with a first direction is a different sub-route from a path/route with a second direction opposing the first direction. In some implementations, each sub-route has an associated shape when being plotted. In some embodiments, a sub-route includes more information about the route, such as altitude information. In some cases, the electrified transit vehicle system is configured to process the transit route information to generate the plurality of routes and the plurality of sub-routes.

In some embodiments, the electrified transit vehicle system is configured to identify a route-change to generate the plurality of routes and the plurality of sub-routes. In some cases, the route-change is determined if the stationary time is greater than a threshold. In one example, the threshold is a predetermined threshold. In another example, the electrified transit vehicle system is configured to adjust the threshold, for example, based on the collected telematics data, the location information, and/or the like. In some cases, the electrified transit vehicle system is configured to generate the plurality of routes and the plurality of sub-routes based at least in part on the historical telematics data. In some cases, the electrified transit vehicle system is configured to generate the plurality of routes and the plurality of sub-routes based on the transit route information and the historical telematics data.

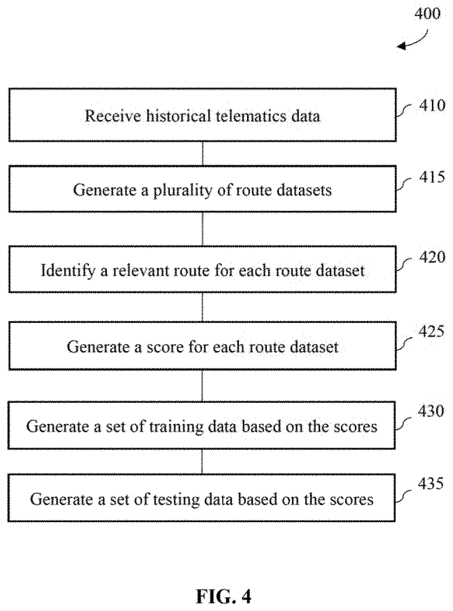

In some embodiments, the electrified transit vehicle system is configured to generate the plurality of routes and the plurality of sub-routes using a machine learning model. In some embodiments, the electrified transit vehicle system is configured to train the machine learning model using the historical telematics data and/or historical operation data. In some embodiments, the electrified transit vehicle system is configured to train the machine learning model using a first subset of the historical telematics data and/or historical operation data. In some cases, the first subset of the historical telematics data is selected using a pre-processing process. One example process of pre-processing training data is illustrated in FIG. 4. The machine learning model may include any suitable machine learning models, deep learning models, and/or the like. In some embodiments, the machine learning model includes at least one of a decision tree, random forest, support vector machine, convolutional neural network, recurrent neural network, and/or the like. Optionally, the system may test the trained machine learning model using a second subset of the historical telematics data and/or historical operation data. In one embodiment, the first subset of the historical telematics data and the second subset of the historical telematics data do not have any overlapping dataset. In another embodiment, the first subset of the historical telematics data and/or historical operation data and the second subset of the historical telematics data and/or historical operation data have at least one overlapping dataset.

In some cases, the machine learning model includes an image classification machine learning model. In some cases, the electrified transit vehicle system is configured to generate a plot using GPS coordinates for each sub-route and the machine learning model is trained to identify the shape of the plot. In some embodiments, the machine learning model comprises a neural network. In some cases, the neural network comprises a plurality of layers. In one embodiments, the neural network includes at least an input layer, one or more hidden layers, and an output layer. In some embodiments, at least one layer of the neural network is for telematics data. In one example, the machine learning model is trained to identify locations using the telematics data.

In some cases, the machine learning model is trained using both the historical telematics data and historical operation data. The operation data includes battery state-of-charge, distance travelled, brake thermal efficiency, and other operation data for an electrified vehicle. In some embodiments, the machine learning model is trained to predict a range estimation using the historical telematics data and the historical operation data. In one example, the machine learning model is a neural network including an input layer for telematics data, an input layer for operation data, an input layer for route information, and/or an output layer for range estimation. In one embodiment, the machine learning model includes a plurality of machine learning models, where a first machine learning model is configured to take inputs of telematics data and route information to predict route, and a second machine learning model is configured to get the predicted route and the operation data as inputs to predict driving range. In one example, the first machine learning model includes an image classification machine learning model.

In some cases, the electrified transit vehicle system is configured to receive location information of an electrified transit vehicle (220). In some embodiments, the location information includes data collected from one or more telematics devices of the electrified transit vehicle (e.g., telematics device 110 in FIG. 1). In some cases, the location information includes data collected from a mobile device in the electrified transit vehicle. In one example, the location information includes a sequence of GPS coordinates. In one example, the location information includes a time sequence of GPS coordinates. In some embodiments, the location information includes speed information and/or brake information of the electrified transit vehicle.

In some implementations, the electrified transit vehicle system is configured to identify a sub-route taken by the electrified transit vehicle (225), for example, based on the location information and/or the plurality of scores. In one embodiment, the identified sub-route has a lowest sub-route score of the scores generated for the sub-routes. In some cases, the electrified transit vehicle system is configured to receive operating conditions of the electrified transit vehicle. In some cases, the operating conditions of the electrified transit vehicle can include, for example, battery state-of-charge, torque, brake thermal efficiency, and/or the like.

In some embodiments, the electrified transit vehicle system is configured to determine a range estimation of the electrified transit vehicle (230), for example, based on the location information and the identified sub-route. In some cases, the electrified transit vehicle system is configured to determine the range estimation based on the operating conditions, the location information, and the identified sub-route. In some cases, the electrified transit vehicle system is configured to determine the range estimation based on altitude information of the identified sub-route. In one example, the altitude information is used to predict future power consumptions of the electrified transit vehicle when traveling in the identified sub-route. In some cases, the system is configured to predict the range estimation using a trained machine learning model. In one example, the range estimation is predicted using a trained artificial neural network, where the artificial neural network includes an output layer for range estimation. In one example, the range estimation is predicted using a trained artificial neural network, where the artificial neural network includes an input layer for route data including altitude information and an output layer for range estimation.

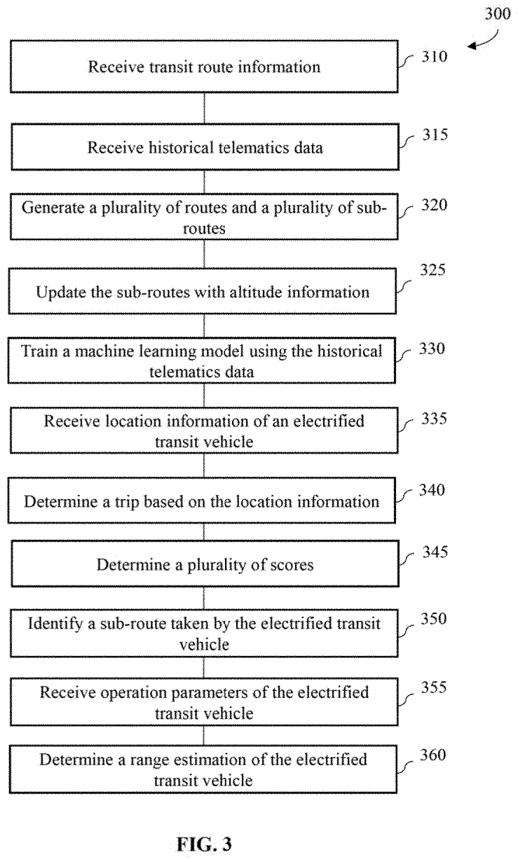

FIG. 3 is an example flow diagram depicting an illustrative method 300 of route identifications/range estimations for electrified transit vehicles, in accordance with embodiments of the present disclosure. Aspects of embodiments of the method 300 may be performed, for example, by one or more processor or system (e.g., the route processor 120 and/or the range processor 130 in FIG. 1, the electrified transit vehicle system 100 in FIG. 1). One or more steps of method 300 are optional and/or can be modified by one or more steps of other embodiments described herein. Additionally, one or more steps of other embodiments described herein may be added to the method 300. First, the electrified transit vehicle system receives transit route information (310) from a transit data source. In one example, the transit data source includes a GTFS database, where the system retrieves the transit route information from the GTFS database. In another example, the transit data source includes a transit system, and the electrified transit vehicle system is configured to receive the transit route information via s software interface (e.g., API, web service, etc.).

In some implementations, the electrified transit vehicle system is configured to receive historical telematics data (315) and optionally historical operation data for transit routes. The historical telematics data can be generated from respective telematics devices of electrified transit vehicles. In some cases, historical telematics data associated with a specific transit route includes a time sequence of GPS coordinates associated with the specific transit route. In some cases, the historical telematics data associated with the specific route further includes data indicative of an altitude associated with one GPS coordinates in the time sequence of GPS coordinates of the specific transit route. In some cases, the historical telematics data associated with the specific route further includes data indicative of a plurality of altitudes associated with a plurality of GPS coordinates in the time sequence of GPS coordinates of the specific transit route.

In some embodiments, the electrified transit vehicle system is configured to generate a plurality of routes and a plurality of sub-routes (320), where each route of the plurality of routes includes one or more sub-routes having a different path from each other. In some cases, a sub-route includes a sequence of GPS coordinates. In some cases, a sub-route includes a time sequence of GPS coordinates. In some cases, a path with a first direction is a different sub-route from a path with a second direction opposing the first direction. In some implementations, each sub-route has an associated shape when being plotted. In some embodiments, a sub-route includes more information about the route, such as altitude information. In some cases, the electrified transit vehicle system is configured to process the transit route information to generate the plurality of routes and the plurality of sub-routes.

In some embodiments, the electrified transit vehicle system is configured to identify a route-change to generate the plurality of routes and the plurality of sub-routes. In some cases, the route-change is determined if the stationary time is greater than a threshold. In one example, the threshold is a predetermined threshold. In some cases, the electrified transit vehicle system is configured to process the historical telematics data to generate the plurality of routes and the plurality of sub-routes. In some cases, the electrified transit vehicle system is configured to process the transit route information and the historical telematics data to generate the plurality of routes and the plurality of sub-routes.

In some cases, the electrified transit vehicle system is configured to update the plurality of sub-routes with altitude information (325), for example, using the historical telematics data. In some cases, the altitude information includes the altitude for each GPS coordinate in the sub-route. In some cases, the altitude information includes altitude data for selected GPS coordinates in the sub-route. In some cases, the altitude information is collected from GPS grid information. In some cases, the historical telematics data associated with the specific route further includes data indicative of an altitude associated with a location in the specific transit route. In some cases, the historical telematics data associated with the specific route further includes data indicative of a plurality of altitudes associated with a plurality of locations in the specific transit route. In some cases, altitude data is collected from barometric sensors on transit vehicles. In some cases, altitude data is retrieved from a data source. In one example, altitude data is retrieved from a data source using location information as inputs.

In some cases, the electrified transit vehicle system is configured to generate the plurality of routes and the plurality of sub-routes using a machine learning model. In some embodiments, the electrified transit vehicle system is configured to train a machine learning model using the historical telematics data and/or historical operation data (330). In some embodiments, the electrified transit vehicle system is configured to train a machine learning model using a first subset of the historical telematics data and/or historical operation data. In some cases, the first subset of the historical telematics data is selected using a pre-processing process. One example process of pre-processing training data is illustrated in FIG. 4.

The machine learning model may include any suitable machine learning models, deep learning models, and/or the like. In some embodiments, the machine learning model includes at least one of a decision tree, random forest, support vector machine, convolutional neural network, recurrent neural network, and/or the like. Optionally, the system may test the trained machine learning model using a second subset of the historical telematics data. In one embodiment, the first subset of the historical telematics data and the second subset of the historical telematics data do not have any overlapping dataset. In another embodiment, the first subset of the historical telematics data and the second subset of the historical telematics data have at least one overlapping dataset.

In some cases, the machine learning model includes an image classification machine learning model. In some cases, the electrified transit vehicle system is configured to generate a plot using GPS coordinates for each sub-route and the machine learning model is trained to identify the shape of the plot. In some embodiments, the machine learning model comprises a neural network. In some cases, the neural network comprises a plurality of layers. In one embodiments, the neural network includes at least an input layer, one or more hidden layers, and an output layer. In some embodiments, at least one layer of the neural network is for telematics data. In one example, the machine learning model is trained to identify locations using the telematics data.

In some cases, the machine learning model is trained using both the historical telematics data and historical operation data. The operation data includes battery state-of-charge, distance travelled, brake thermal efficiency, and other operation data for an electrified vehicle. In some embodiments, the machine learning model is trained to predict a range estimation using the historical telematics data and the historical operation data. In one example, the machine learning model is a neural network including an input layer for telematics data, an input layer for operation data, an input layer for route information, and/or an output layer for range estimation. In one embodiment, the machine learning model includes a plurality of machine learning models, where a first machine learning model is configured to take inputs of telematics data and route information to predict route, and a second machine learning model is configured to get the predicted route and the operation data as inputs to predict driving range. In one example, the first machine learning model includes an image classification machine learning model.

In some cases, the electrified transit vehicle system is configured to receive location information of an electrified transit vehicle (335). In some embodiments, the location information includes data collected from one or more telematics devices of the electrified transit vehicle (e.g., telematics device 110 in FIG. 1). In some cases, the location information includes data collected from a mobile device in the electrified transit vehicle. In one example, the location information includes a sequence of GPS coordinates. In one example, the location information includes a time sequence of GPS coordinates. In some embodiments, the location information includes speed information and/or brake information of the electrified transit vehicle.

In some implementations, the electrified transit vehicle system is configured to determine a trip of the electrified transit vehicle based on the location information (340). In some cases, the electrified transit vehicle takes a plurality of different routes/sub-routes. In such cases, the electrified transit vehicle system is configured to determine a start location of a trip based on stationary time of the vehicle. In some cases, the start location is determined if the stationary time is greater than a threshold. In one example, the threshold is a predetermined threshold. In another example, the electrified transit vehicle system is configured to adjust the threshold, for example, based on the collected telematics data, the location information, and/or the like.

In some embodiments, the electrified transit vehicle system is configured to determine a plurality of scores of the trip (345), for example, in comparison to the generated sub-routes. The scores are also referred to as sub-route scores. In some cases, the electrified transit vehicle system is configured to generate a plurality of scores associated with a plurality of selected sub-routes for the electrified transit vehicle, where each score of the plurality of scores is associated with a respective sub-route and generated based on a distance between a location of the electrified transit vehicle and the respective sub-route. In some cases, the distance is determined using GPS coordinates associated with the location and GPS coordinates associated with the respective sub-route. In some cases, a score for a sub-route can be determined based on a plurality of locations of the electrified transit vehicle and the respective sub-route. In one example, the score for a sub-route is determined based on the smallest distance of the plurality of the locations of the electrified transit vehicle to the respective sub-route.

In one example, the score for a sub-route is determined based on the average distance of the plurality of the locations of the electrified transit vehicle to reference locations of the respective sub-route. In one example, a distance of a location to a sub-route is computed using the shortest distance from the location to the sub-route. For example, the electrified transit vehicle system may use Delaunay Triangulation algorithm to compute the distance. In some cases, the score is a normalized score based on the distances computed to a plurality of sub-routes. In one example, the score is normalized using the number of reference locations identified in the sub-routes. In some cases, the score is determined using a trained machine learning model. In some cases, the score is determined using a trained artificial neural network, where the artificial neural network includes an output layer for sub-route scores.

In some implementations, the electrified transit vehicle system is configured to identify a sub-route taken by the electrified transit vehicle (350), for example, based on the location information and/or the plurality of scores. In one embodiment, the identified sub-route has a lowest sub-route score of the scores generated for the sub-routes. In some cases, the electrified transit vehicle system is configured to receive operating conditions of the electrified transit vehicle (355). In some cases, the operating conditions of the electrified transit vehicle can include, for example, battery state-of-charge, torque, brake thermal efficiency, and/or the like.

In some embodiments, the electrified transit vehicle system is configured to determine a range estimation of the electrified transit vehicle (360), for example, based on the location information and the identified sub-route. In some cases, the electrified transit vehicle system is configured to determine the range estimation based on the operating conditions, the location information, and the identified sub-route. In some cases, the electrified transit vehicle system is configured to determine the range estimation based on altitude information of the identified sub-route. In one example, the altitude information is used to predict future power consumptions of the electrified transit vehicle when traveling in the identified sub-route. In some cases, the system is configured to predict the range estimation using a trained machine learning model. In one example, the range estimation is predicted using a trained artificial neural network, where the artificial neural network includes an output layer for range estimation.

FIG. 4 is an example flow diagram depicting an illustrative method 400 of pre-processing historical telematics data to be used to train a machine learning model, in accordance with embodiments of the present disclosure. Aspects of embodiments of the method 400 may be performed, for example, by one or more processor or system (e.g., the route processor 120 and/or the range processor 130 in FIG. 1, the electrified transit vehicle system 100 in FIG. 1). One or more steps of method 400 are optional and/or can be modified by one or more steps of other embodiments described herein. Additionally, one or more steps of other embodiments described herein may be added to the method 400. First, the electrified transit vehicle system is configured to receive historical telematics data (410) for transit routes.

The historical telematics data can be generated from respective telematics devices of electrified transit vehicles. In some cases, historical telematics data associated with a specific transit route includes a sequence of GPS coordinates associated with the specific transit route. In some cases, historical telematics data associated with a specific transit route includes a time sequence of GPS coordinates associated with the specific transit route. In some cases, the historical telematics data associated with the specific route further includes data indicative of an altitude associated with a location in the specific transit route. In some cases, the historical telematics data associated with the specific route further includes data indicative of a plurality of altitudes associated with a plurality of locations in the specific transit route.

In some embodiments, the electrified transit vehicle system is configured to generate a plurality of route datasets (415) from the historical telematics data. In some cases, the route datasets are generated based on time separation (e.g., stationary time greater than a threshold). In some cases, the route datasets are generated from a match to a transit route based on the transit route information. In one example, the system is configured to retrieve the transit route information from the GTFS database. In another example, the transit data source includes a transit system, and the electrified transit vehicle system is configured to receive the transit route information via s software interface (e.g., API, web service, etc.).

In some implementations, the system is configured identify a relevant route for each route dataset (420). In one example, each route dataset is used to generate a plot and the system uses the plot to identify a relevant route/sub-route. In one example, the system is configured to determine a confidence value indicative of a similarity of a route dataset to a transit route/sub-route. In some cases, the system can generate a score for each route dataset (425). In one example, the score includes the confidence value indicative of the similarity to the identified relevant route. In one example, the score is generated based on a distance between the location data in the route dataset and the identified relevant route. In some cases, a score for a route dataset can be determined based on a plurality of locations in the route dataset and the identified relevant route. In one example, the score for a route dataset is generated based on the smallest distance of the plurality of the locations to the identified relevant route.

In one example, the score for a route dataset is generated based on the average distance of the plurality of the locations in the route dataset to reference locations of the identified relevant route. In one example, a distance of a location to a route is computed using the shortest distance from the location to the route. For example, the route processor may use Delaunay Triangulation algorithm to compute the distance. In one example, the score is normalized using the number of reference locations identified in the route. In some cases, the score is determined using a trained machine learning model. In some cases, the score is determined using a trained artificial neural network, where the artificial neural network includes an output layer for sub-route scores.

In some embodiments, the electrified transit vehicle system is configured to generate a set of training data based on the scores (430). In one example, the set of training data includes route datasets having scores greater than a threshold. In some implementations, the system is configured to generate a set of testing data based on the scores (435). In some cases, the set of testing data includes route datasets having scores greater than a threshold. In some cases, the set of testing data includes one or more route datasets having scores lower than the threshold.

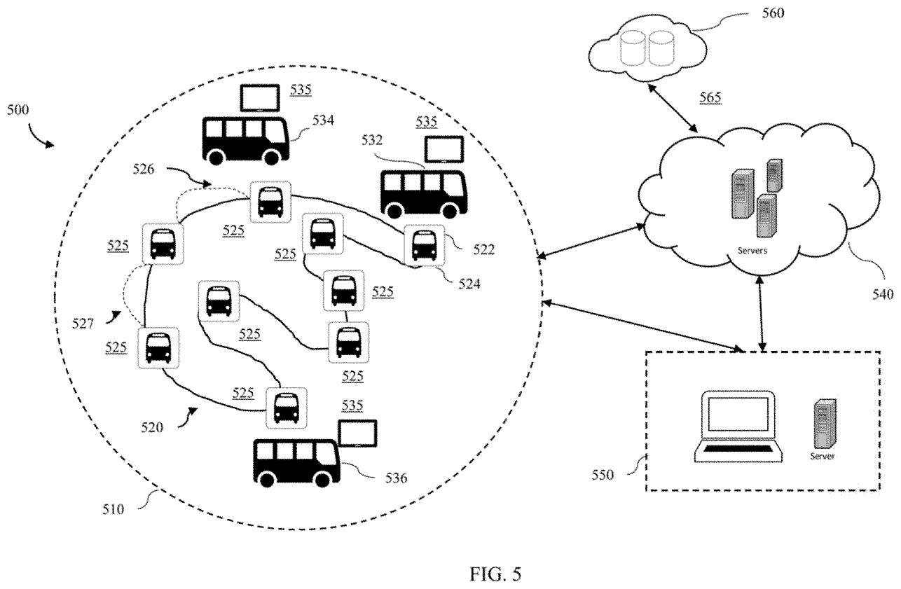

FIG. 5 depicts an illustrative diagram of an electrified transit vehicle environment 500, in accordance with embodiments of the subject matter of the disclosure. In some implementations, one or more components of the electrified transit vehicle environment 500 can be optional. In some implementations, the electrified transit vehicle environment 500 can include other components not illustrated in the diagram. In the illustrated example, the electrified transit vehicle environment 500 includes one or more electrified transit vehicles 510 (e.g., electrified transit vehicle 532, electrified transit vehicle 534, electrified transit vehicle 536), an electrified transit vehicle system 540 (e.g., the electrified transit vehicle system 100 illustrated in FIG. 1), a transit controller 550, and a transit data source 560. The system 540 may receive transit route information 565 from the transit data source 560. In one example, the transit data source 560 includes a GTFS database, where the system 540 retrieves the transit route information from the GTFS database. In another example, the transit data source 560 includes a transit system, and the electrified transit vehicle system 540 is configured to receive the transit route information via s software interface (e.g., API, web service, etc.).

In some embodiments, the transit route information 565 includes information of a specific transit route 520. In some examples, the specific transit route 520 includes a preset start location 522, a preset end location 524, and one or more preset transit stop locations 525. In certain examples, the preset start location 522 is at a same location as the preset end location 524, as illustrated in FIG. 5.

In certain embodiments, the specific transit route 520 includes sub-route 526 and sub-route 527. As illustrated, the sub-route 526 has a path different from the sub-route 527. In one example, the electrified transit vehicle 534 is on the sub-route 526.

The electrified transit vehicle system 540 may receive operation data of one or more electrified transit vehicles 510. The operation data includes, for example, speed, power level of the engine, torque, battery health (e.g., the efficiency of retaining charges) of at least one of one or more battery packs, battery state-of-charge (SOC), brake thermal efficiency (BTE), and/or the like. The operation data may also include vehicle sensor data such as, for example, noise data, vibration data, harshness data, exhaust gas temperature, catalyst temperature, altitude data, and/or the like. In some embodiments, the electrified transit vehicle includes an altitude sensor, for example, a barometric sensor. In some examples, the electrified transit vehicle 532 has battery health different from the battery health of the electrified transit vehicle 534. In certain examples, the electrified transit vehicle 532 has battery health different from the battery health of the electrified transit vehicle 536.

In some implementations, the electrified transit vehicle system 540 is configured to receive historical telematics data for transit routes. In some cases, the electrified transit vehicle system 540 is configured to retrieve the historical telematics data from a data repository. The historical telematics data can be generated from respective telematics devices of electrified transit vehicles 510. In some cases, historical telematics data associated with a specific transit route includes a time sequence of GPS coordinates associated with the specific transit route. In some cases, the historical telematics data associated with the specific route further includes data indicative of an altitude associated with a location in the specific transit route. In some cases, the historical telematics data associated with the specific route further includes data indicative of a plurality of altitudes associated with a plurality of locations in the specific transit route. In some cases, altitude data is collected from barometric sensors on transit vehicles. In some cases, altitude data is retrieved from a data source. In one example, altitude data is retrieved from a data source using location information as inputs.

In some embodiments, the electrified transit vehicle system 540 is configured to generate a plurality of routes and a plurality of sub-routes, where each route of the plurality of routes includes one or more sub-routes having a different path from each other. In some cases, a sub-route includes a sequence of GPS coordinates. In some implementations, a plurality of sub-routes of a route have a different path/direction from each other, while the plurality of sub-routes (e.g., sub-route 526, sub-route 527) have the same starting location 522, the same end location 524, and one or more same transit stop locations 525. In certain implementations, a plurality of sub-routes of a route have a different path/direction from each other, while the plurality of sub-routes have the same starting location, the same end location, and one or more same transit stop locations. In some cases, a sub-route includes a time sequence of GPS coordinates. In some cases, a route with a first direction is a different sub-route from the route with a second direction opposing the first direction. In some implementations, each sub-route has an associated shape when being plotted. In some embodiments, a sub-route includes more information about the route, such as altitude information.

In some cases, the electrified transit vehicle system 540 is configured to process the transit route information to generate the plurality of routes and the plurality of sub-routes. In some embodiments, the electrified transit vehicle system 540 is configured to identify a route-change to generate the plurality of routes and the plurality of sub-routes. In some cases, the route-change is determined if the stationary time is greater than a threshold. In one example, the threshold is a predetermined threshold. In some cases, a sub-route includes a sequence of GPS coordinates and at least one altitude associated with one GPS coordinates in the sequence of GPS coordinates. In some cases, a sub-route includes a sequence of GPS coordinates and associated altitudes.

In some cases, the electrified transit vehicle system 540 is configured to process the historical telematics data to update the plurality of routes and the plurality of sub-routes. In some cases, the electrified transit vehicle system 540 is configured to process the transit route information and the historical telematics data to generate the plurality of routes and the plurality of sub-routes. In one example, if an electrified transit vehicle (e.g., electrified transit vehicle 534) is at a location that is on the specific route 520, a sub-route 526 can be created. In some examples, the electrified transit vehicle system 540 is configured to update the plurality of sub-routes with altitude information, for example, using the historical telematics data. In some cases, the altitude information includes the altitude for each GPS coordinates in the sub-route. In some cases, the altitude information includes altitude data for selected GPS coordinates in the sub-route. In some cases, the altitude information is collected from GPS grid information. In some cases, the electrified transit vehicle system 540 is configured to generate the plurality of routes and the plurality of sub-routes using the trained machine learning model, wherein the machine learning model is trained using at least a part of the historical telematics data.

In some embodiments, the electrified transit vehicle system 540 is configured to train a machine learning model using the historical telematics data and/or historical operation data. In some embodiments, the electrified transit vehicle system 540 is configured to train a machine learning model using a first subset of the historical telematics data and/or historical operation data. In some cases, the first subset of the historical telematics data is selected using a pre-processing process. The machine learning model may include any suitable machine learning models, deep learning models, and/or the like. In some embodiments, the machine learning model includes at least one of a decision tree, random forest, support vector machine, convolutional neural network, recurrent neural network, and/or the like. Optionally, the electrified transit vehicle system 540 may test the trained machine learning model using a second subset of the historical telematics data and/or historical operation data. In one embodiment, the first subset of the historical telematics data and/or historical operation data and the second subset of the historical telematics data and/or historical operation data do not have any overlapping dataset. In another embodiment, the first subset of the historical telematics data and the second subset of the historical telematics data have at least one overlapping dataset.

In some cases, the machine learning model includes an image classification machine learning model. In some cases, the electrified transit vehicle system 540 is configured to generate a plot (e.g., similar to route and/or sub-route 520, 526, 527) using GPS coordinates for each sub-route and the machine learning model is trained to identify the shape of the plot. In some embodiments, the machine learning model comprises a neural network. In some cases, the neural network comprises a plurality of layers. In some embodiments, the neural network includes at least an input layer, one or more hidden layers, and an output layer. In some embodiments, at least one input layer of the neural network is for telematics data. In some embodiments, at least one input layer of the neural network is for operation data. In one example, the machine learning model is trained to identify locations using the telematics data.

In some cases, the machine learning model is trained using both the historical telematics data and historical operation data. The operation data includes, for example, battery state-of-charge, distance travelled, brake thermal efficiency, and other operation data for an electrified vehicle. In some embodiments, the machine learning model is trained to predict a range estimation using the historical telematics data and the historical operation data. In one example, the machine learning model is a neural network including an input layer for telematics data, an input layer for operation data, an input layer for route information, and/or an output layer for range estimation. In one embodiment, the machine learning model includes a plurality of machine learning models, where a first machine learning model is configured to take inputs of telematics data and route information to predict route, and a second machine learning model is configured to get the predicted route and the operation data as inputs to predict driving range. In one example, the first machine learning model includes an image classification machine learning model.

In some cases, the electrified transit vehicle system 540 is configured to receive location information of an electrified transit vehicle. In some embodiments, the location information includes data collected from one or more telematics devices of the electrified transit vehicles 510. In some cases, the location information includes data collected from a mobile device in the electrified transit vehicle. In one example, the location information includes a sequence of GPS coordinates. In one example, the location information includes a time sequence of GPS coordinates. In some embodiments, the location information includes speed information and/or brake information of the electrified transit vehicle.

In some embodiments, the electrified transit vehicle system 540 is configured to determine a plurality of scores associated with the trip, for example, in comparison to the generated sub-routes. The scores are also referred to as sub-route scores. In some cases, the electrified transit vehicle system 540 is configured to determine a plurality of scores associated with a plurality of selected sub-routes for the electrified transit vehicle, where each score of the plurality of scores is associated with a respective sub-route and generated based on a distance between a location of the electrified transit vehicle and the respective sub-route. In some cases, the distance is determined based on GPS coordinates. In some cases, a score for a sub-route can be determined based on a plurality of locations of the electrified transit vehicle and the respective sub-route. In one example, the score for a sub-route is determined based on the smallest distance of the plurality of the locations of the electrified transit vehicle to the respective sub-route.

In one example, the score for a sub-route is determined based on the average distance of the plurality of the locations of the electrified transit vehicle to reference locations of the respective sub-route. In one example, a distance of a location to a sub-route is computed using the shortest distance from the location to the sub-route. For example, the electrified transit vehicle system 540 may use Delaunay Triangulation algorithm to compute the distance. In some cases, the score is a normalized score based on the distances computed to a plurality of sub-routes. In one example, the score is normalized using the number of reference locations identified in the sub-routes. In some cases, the score is determined using the trained machine learning model. In some cases, the score is determined using the trained artificial neural network, where the artificial neural network includes an output layer for sub-route scores.

In some implementations, the electrified transit vehicle system 540 is configured to identify a sub-route taken by the electrified transit vehicle, for example, based on the location information and/or the plurality of scores. In one embodiment, the identified sub-route has the lowest sub-route score of the scores determined for the sub-routes. In certain examples, the electrified transit vehicle system 540 is configured to receive operating conditions of the electrified transit vehicle. In some examples, the operating conditions of the electrified transit vehicle can include, for example, battery health, battery state-of-charge, torque, brake thermal efficiency, and/or the like.

In some embodiments, the electrified transit vehicle system 540 is configured to determine a range estimation of the electrified transit vehicle, for example, based on the location information, the identified sub-route, and at least one of one or more transit stop locations of the specific route associated with the identified sub-route. In some implementations, the electrified transit vehicle system 540 is configured to determine the range estimation based on the operating conditions/data, the location information, the identified sub-route, and transit stop locations, and the end location. In some examples, the electrified transit vehicle system 540 determines different range estimations for a same electrified transit vehicle at a same location of a same transit route that is traveling at a different time of day. In certain examples, the electrified transit vehicle system 540 determines different range estimations for a same electrified transit vehicle at a same location of a same transit route that is traveling at a different sub-route. In some examples, the electrified transit vehicle system 540 determines different range estimations for two electrified transit vehicles at a same location of a same transit route that have different battery health.

In certain implementations, the electrified transit vehicle system 540 is configured to determine the range estimation based at least in part on altitude information of the identified sub-route. In one example, the altitude information is used to predict future power consumptions of the electrified transit vehicle when traveling in the identified sub-route (e.g., sub-route 527). In some examples, the electrified transit vehicle system 540 is configured to predict the range estimation using the trained machine learning model. In one example, the range estimation is predicted using the trained artificial neural network, where the artificial neural network includes an output layer for range estimation.

In some embodiments, the electrified transit vehicle system 540 may use an adaptive algorithm which learns from historical data (e.g., energy spent over distance traveled) to determine the distance vehicle can travel in the remaining energy available in the battery. With the information of the identified sub-route the vehicle is traveling, the accuracy of range estimation can be improved.

In certain embodiments, the electrified transit vehicle system 540 transmit a first indication of the range estimation to the transit controller 550. In some examples, the transit controller 550 allows an operator to monitor, control, and/or manage transit vehicles 510. In certain examples, the transit controller 550 implements a portal to allow an operator to monitor, control, and/or manage transit vehicles 510. In some examples, the portal of the transit controller 550 includes one or more alerts and/or messages. In certain examples, the electrified transit vehicle system 540 transmit a second indication of the range estimation to the electrified transit vehicle 510, where the second indication may be presented in the dashboard 535 of the transit vehicle 510.

In certain embodiments, the electrified transit vehicle system 540 is configured to determine a remaining time for the electrified transit vehicle 510 to get to a preset end location 524 of the specific route 520 based at least in part on the specific route 520, the identified sub-route (e.g., sub-route 526), the received location information, and the preset end location 524 of the specific route 520. In some examples, the electrified transit vehicle system 540 is configured to transmit the remaining time to the transit controller 550.

Various modifications and additions can be made to the exemplary embodiments discussed without departing from the scope of the present invention. For example, while the embodiments described above refer to specific features, the scope of this invention also includes embodiments having different combinations of features and embodiments that do not include all of the above described features.

What is claimed is:

1. A system, comprising:
one or more memories having instructions; and
one or more processors configured to execute the instructions to perform operations comprising:
receiving transit route information from a transit data source;
generating a plurality of routes and a plurality of sub-routes based on the transit route information, each route of the plurality of routes comprising one or more sub-routes having a different path from each other, each route of the plurality of routes including a preset start location, a preset end location, and one or more preset transit stop locations;
receiving location information of an electrified transit vehicle;
identifying a sub-route being taken by the electrified transit vehicle based on the location information, the identified sub-route being one of one or more of sub-routes associated with a specific route of the plurality of routes; and
determining a range estimation of the electrified transit vehicle based on the received location information, the identified sub-route, and at least one of one or more transit stop locations of the specific route.

2. The system of claim 1, wherein the operations further comprise:
transmitting a first indication of the range estimation to a transit controller; and
transmitting a second indication of the range estimation to the electrified transit vehicle.

3. The system of claim 2, wherein the operations further comprise:
estimating a remaining time for the electrified transit vehicle to get to a preset end location of the specific route based at least in part on the specific route, the identified sub-route, the received location information, and the preset end location of the specific route; and
transmitting the remaining time to the transit controller.

4. The system of claim 1, wherein the operations further comprise:
receiving historical telematics data associated with the transit route information, the historical telematics data associated with the specific route comprising a time sequence of GPS coordinates associated with the specific route, the historical telematics data associated with the specific route further comprises data indicative of an altitude associated with a location in the specific route; and
updating the one or more sub-routes associated with the specific route based on the historical telematics data;
wherein the identifying a sub-route being taken by the electrified transit vehicle comprises identifying the sub-route based on the transit route information, the one or more sub-routes and the received location information.

5. The system of claim 4, wherein the generating a plurality of routes and a plurality of sub-routes comprises generating the plurality of routes and the plurality of sub-routes using a machine learning model, wherein the machine learning model is trained using at least a part of the historical telematics data.

6. The system of claim 5, wherein each sub-route of the plurality of sub-routes comprises a sequence of GPS coordinates and at least one altitude associated with one GPS coordinates in the sequence of GPS coordinates, wherein the determining a range estimation of the electrified transit vehicle comprises determining the range estimation based on a sequence of GPS coordinates and at least one altitude of the identified sub-route.

7. The system of claim 1, wherein the determining a range estimation of the electrified transit vehicle comprises determining the range estimation based on the received location information, the identified sub-route, the at least one of one or more transit stop locations of the specific route, and one or more operating conditions of the electrified transit vehicle.

8. The system of claim 1, wherein the one or more operating conditions of the electrified transit vehicle include battery health of at least one of one or more battery packs of the electrified transit vehicle.

9. The system of claim 1, wherein the operations further comprise:
generating a plurality of scores associated with a plurality of selected sub-routes corresponding to the selected route for the electrified transit vehicle, each score of the plurality of scores being associated with a respective selected sub-route and generated based on a distance between a location of the electrified transit vehicle and the respective selected sub-route;
wherein the identified sub-route is determined based on the plurality of scores.

10. The system of claim 9, wherein the distance is determined using GPS coordinates associated with the location and GPS coordinates associated with the respective selected sub-route.

11. A method implemented by a system having one or more processors and one or more memories, the method comprising:
receiving transit route information from a transit data source;
generating a plurality of routes and a plurality of sub-routes based on the transit route information, each route of the plurality of routes comprising one or more sub-routes having a different path from each other, each route of the plurality of routes including a preset start location, a preset end location, and one or more preset transit stop locations;
receiving location information of an electrified transit vehicle;
identifying a sub-route being taken by the electrified transit vehicle based on the location information, the identified sub-route being one of one or more of sub-routes associated with a specific route of the plurality of routes; and
determining a range estimation of the electrified transit vehicle based on the received location information, the identified sub-route, and at least one of one or more transit stop locations of the specific route.

12. The method of claim 11, further comprising:
transmitting a first indication of the range estimation to a transit controller; and
transmitting a second indication of the range estimation to the electrified transit vehicle.

13. The method of claim 12, further comprising:
estimating a remaining time for the electrified transit vehicle to get to a preset end location of the specific route based at least in part on the specific route, the identified sub-route, the received location information, and the preset end location of the specific route; and
transmitting the remaining time to the transit controller.

14. The method of claim 11, further comprising:
receiving historical telematics data associated with the transit route information, the historical telematics data associated with the specific route comprising a time sequence of GPS coordinates associated with the specific route, the historical telematics data associated with the specific route further comprises data indicative of an altitude associated with a location in the specific route; and
updating the one or more sub-routes associated with the specific route based on the historical telematics data;
wherein the identifying a sub-route being taken by the electrified transit vehicle comprises identifying the sub-route based on the transit route information, the one or more sub-routes and the received location information.

15. The method of claim 14, wherein the generating a plurality of routes and a plurality of sub-routes comprises generating the plurality of routes and the plurality of sub-routes using a machine learning model, wherein the machine learning model is trained using at least a part of the historical telematics data.

16. The method of claim 15, wherein each sub-route of the plurality of sub-routes comprises a sequence of GPS coordinates and at least one altitude associated with one GPS coordinates in the sequence of GPS coordinates, wherein the determining a range estimation of the electrified transit vehicle comprises determining the range estimation based on a sequence of GPS coordinates and at least one altitude of the identified sub-route.

17. The method of claim 11, wherein the determining a range estimation of the electrified transit vehicle comprises determining the range estimation based on the received location information, the identified sub-route, the at least one of one or more transit stop locations of the specific route, and one or more operating conditions of the electrified transit vehicle.

18. The method of claim 11, wherein the one or more operating conditions of the electrified transit vehicle include battery health of at least one of one or more battery packs of the electrified transit vehicle.

19. The method of claim 11, further comprising:
generating a plurality of scores associated with a plurality of selected sub-routes corresponding to the selected route for the electrified transit vehicle, each score of the plurality of scores being associated with a respective selected sub-route and generated based on a distance between a location of the electrified transit vehicle and the respective selected sub-route;
wherein the identified sub-route is determined based on the plurality of scores.

20. The method of claim 19, wherein the distance is determined using GPS coordinates associated with the location and GPS coordinates associated with the respective selected sub-route.
